(19) United States
(12) Patent Application Publication
(10) Pub. No.: US 2005/0082500 A1
(43) Pub. Date: Apr. 21, 2005

(54) Method of and apparatus for reading out image

(75) Inventor: Akira Yamaguchi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/963,569

(22) Filed: Oct. 14, 2004

(30) Foreign Application Priority Data
Oct. 16, 2003 (JP) 355810/2003

(51) Int. Cl. G01T 1/00

(52) U.S. Cl. 250/580

(57) ABSTRACT

An electric current is detected at a plurality of different gains G for each pixel from a solid sensor which outputs an electric current according to the electrostatic latent image recorded thereon. Analog signals corresponding to the amounts of electric currents are digitized to digital signals. A digital signal corresponding to a gain which is the largest in the gains G at which the electric current is detected for each pixel is selected when there is an unsaturated digital signal in the digital signals corresponding to the gains G for the pixel, while one of the digital signals corresponding to the gains at which the electric current is detected for the pixel is selected when there is no unsaturated digital signal in the digital signals corresponding to the gains G for the pixel. An image signal is made up on the basis of the selected digital signals.

### BACKGROUND OF THE INVENTION

1. Field of the Invention

This invention relates to a method of and apparatus for reading an electrostatic latent image recorded on a solid sensor and forms an image.

2. Description of the Related Art

In taking an X-ray image for a medical purpose, various X-ray image taking apparatuses where a solid sensor (having semiconductor as a main part) is employed to detect X-rays passing through an object and to obtain an image signal representing an X-ray image of the object have been proposed and put into practice.

Various systems of the solid sensors employed in the X-ray image taking apparatuses have been proposed. For example, from the viewpoint of electric charge generating process for converting the X-rays to electric charges, there have been known those of a photo-conversion system in which signal charges obtained by detecting fluorescence emitted from phosphors upon exposure to X-rays by a photoconductive layer are once stored in a charge accumulating portion to record an electrostatic latent image and an electric current is output according to the electrostatic latent image or those of a direct-conversion system in which signal charges generated in a photoconductive layer upon exposure to X-rays are collected by a charge collecting electrode and are once stored in a charge accumulating portion to record an electrostatic latent image and an electric current is output according to the electrostatic latent image. The solid sensors of this system includes therein a photoconductive layer and a charge collecting electrode as the main part thereof.

Further, from the viewpoint of electric charge read-out process for reading out the recorded latent image, there have been known those of an optical read-out system in which reading light (reading electromagnetic wave) is projected onto the solid sensor or of a TFT read-out system in which TFTs (thin film transistors) connected to the charge accumulating portion are scanned and driven to readout the electrostatic latent image as disclosed, for instance, in Japanese Unexamined Patent Publication No. 2000-244824.

Further, as disclosed, for instance, in U.S. Pat. No. 6,268,614, we, this applicant, have proposed an improved direct-conversion system solid sensor. The improved direct-conversion system solid sensor is a solid sensor which is both of the direct conversion system and the optical read-out system and comprises a recording photoconductive layer which exhibits conductivity upon exposure to recording light (X-rays or fluorescence generated upon exposure to X-rays), a charge transfer layer which behaves like a substantially insulating material to the electric charge in the same polarity as the latent image and behaves like a substantially conductive material to the electric charge in the polarity opposite to that of the latent image and a reading photoconductive layer which exhibits conductivity upon exposure to reading electromagnetic waves, which layers are superposed one on another in this order. In the improved direct-conversion system solid sensor, the signal charges representing image information are stored on the interface between the recording photoconductive layer and the charge transfer layer (the charge accumulating portion) to record an electrostatic latent image, and electrodes (a first conductive layer and a second conductive layer) are superposed on the respective sides of the three layers. In the solid sensors of this system the recording photoconductive layer, the charge transfer layer and the reading photoconductive layer form the main part thereof.

In the image taking apparatuses where the solid sensor is employed, the electric current output from the solid sensor is detected and an analog signal corresponding to the amount of the electric current is converted to a digital signal to form an image signal. However, since the current output from the solid sensor is very weak, a logarithmic amplifier cannot be employed to detect the current and a linear circuit is generally employed to detect the current. Accordingly, if the A/D converter is set so that its full scale conforms to a maximum amount of the X-rays, the bit resolution in the low dose range deteriorates and the reproduced image will be a defective image such as a bit drop image when the digitized image signal is corrected, whereas when a high bit A/D converter which can ensure a high bit resolution over the entire dose range from the low dose range to the high dose range is employed, the cost is increased.

### SUMMARY OF THE INVENTION

In view of the foregoing observations and description, the primary object of the present invention is to provide a method of and apparatus for detecting the electric current output from the solid sensor and generating an image signal by converting an analog signal corresponding to the amount of the electric current to a digital signal wherein the bit resolution in the low dose range can be kept high without use of a high bit A/D converter.

In accordance with an aspect of the present invention, there is provided a method of reading an image comprising the steps of

detecting an electric current at a plurality of different gains G for each pixel from a solid sensor on which image information is recorded as an electrostatic latent image upon exposure to recording light bearing thereon the image information and which outputs an electric current according to the electrostatic latent image recorded thereon,

digitizing analog signals, corresponding to the amounts of electric currents which are detected at a plurality of different gains G, to digital signals,

selecting a digital signal corresponding to a gain which is the largest in the gains G at which the electric current is detected for each pixel when there is an unsaturated digital signal in the digital signals corresponding to the gains G for the pixel, while selecting one of the digital signals corresponding to the gains at which the electric current is detected for the pixel when there is no unsaturated digital signal in the digital signals corresponding to the gains G for the pixel, and

making up an image signal on the basis of the selected digital signals.

In accordance with another aspect of the present invention, there is provided an apparatus for reading an image comprising

a solid sensor on which image information is recorded as an electrostatic latent image upon exposure to recording light bearing thereon the image information and which outputs an electric current according to the electrostatic latent image recorded thereon,

a current detecting means which is adapted to detect an electric current output from the solid sensor at a plurality of different gains G for each pixel,

an A/D conversion means which digitizes analog signals, corresponding to the amounts of electric currents which are detected at a plurality of different gains G, to digital signals, and

an image signal generating means which selects a digital signal corresponding to a gain which is the largest in the gains G at which the electric current is detected for each pixel when there is an unsaturated digital signal in the digital signals corresponding to the gains G for the pixel, while selects one of the digital signals corresponding to the gains at which the electric current is detected for the pixel when there is no unsaturated digital signal in the digital signals corresponding to the gains G for the pixel, and makes up an image signal on the basis of the selected digital signals.

In this specification, the “solid sensor” is a sensor on which image information is recorded as an electrostatic latent image upon exposure to recording light bearing thereon the image information and which outputs an electric current (a signal) according to the electrostatic latent image recorded thereon. In the “solid sensor”, the recording light impinging thereupon is converted to electric charges directly or after once converted to light and the electric charges are output externally, whereby a signal representing an image of the object is obtained.

There are various types of the solid sensors. For example, from the viewpoint of electric charge generating process for converting the recording light to electric charges, there have been known those of a photo-conversion system in which signal charges obtained by detecting fluorescence emitted from phosphors upon exposure to the recording light by a photoconductive layer are once stored in a charge accumulating portion to record an electrostatic latent image and an electric current is output according to the electrostatic latent image or those of a direct-conversion system in which signal charges generated in a photoconductive layer upon exposure to the recording light are collected by a charge collecting electrode and are once stored in a charge accumulating portion to record an electrostatic latent image and an electric current is output according to the electrostatic latent image, and from the viewpoint of electric charge read-out process for reading out the recorded latent image, there have been known those of an optical read-out system in which reading light (reading electromagnetic wave) is projected onto the solid sensor or of a TFT read-out system in which TFTs (thin film transistors) connected to the charge accumulating portion are scanned and driven to read out the electrostatic latent image. Further, as disclosed, for instance, in Japanese Unexamined Patent Publication No. 2000-105297, we, this applicant, have proposed an improved direct-conversion system solid sensor which is a combination of the direct conversion system and the optical read-out system. Further, the solid sensor may comprises a CCD which detects evanescent light generated from an imaging plate or the like.

The “recording light” as used here means an electromagnetic wave carrying thereon image information, and may be any so long as it can cause a solid sensor to store image information carried thereon upon exposure to the recording light. For example, the recording light may be light or a radiation.

Further, the “unsaturated digital signal” means a digital signal which represents a value other than the maximum value which the digital signal can take.

Further, the expression “making up an image signal on the basis of the selected digital signals” means to make up an image signal after matching the digital signal and the analog signal with each other by carrying out an operation such as multiplication or division on the digital signals according to the gain G since a digital signal converted by the A/D conversion means can correspond to a plurality of analog signals detected at different gains G.

In the apparatus of this invention, it is preferred that the

gain Gₘᵢₙ satisfies formula G=Gₘᵢₙ×2^{k}, wherein Gun is the minimum gain, k is an integer not smaller than 0 and the gain is the minimum when k is 0.

Further, it is preferred that the image signal generating means carries out bit shift of the digital signals. It is preferred that the amount S of the bit shift satisfies formula S=S₀+kₘₐₓ−k wherein S₀ represents a predetermined amount of the bit shift and kₘₐₓ represents the multiplier when the gain is the maximum.

In accordance with the method of and apparatus for reading an image of the present invention, since an electric current is detected at a plurality of different gains G for each pixel from a solid sensor on which image information is recorded as an electrostatic latent image upon exposure to recording light bearing thereon the image information and which outputs an electric current according to the electrostatic latent image recorded thereon, analog signals, corresponding to the amounts of electric currents which are detected at a plurality of different gains G, are digitized to digital signals, a digital signal corresponding to a gain which is the largest in the gains G at which the electric current is detected for each pixel is selected when there is an unsaturated digital signal in the digital signals corresponding to the gains G for the pixel, while one of the digital signals corresponding to the gains at which the electric current is detected for the pixel is selected when there is no unsaturated digital signal in the digital signals corresponding to the gains G for the pixel, and an image signal is made up on the basis of the selected digital signals, the bit resolution in the low dose range can be kept high even if the A/D converter is set so that its full scale conforms to a maximum amount of the X-rays since the image signal is generated in the low dose range by digitizing an analog signal detected at a high gain.

Further, when the gain G satisfies formula G=Gₘᵢₙ×2^{k}, the operation to be executed when an image signal is generated on the basis of the selected digital signals is facilitated.

Further, when the image signal generating means carries out bit shift of the digital signals, operation to be executed when an image signal is generated on the basis of the selected digital signals can be executed at a high efficiency. When the amount S of the bit shift satisfies formula S=S₀+kₘₐₓ−k at this time with the gain G satisfying formula G=Gₘᵢₙ×2^{k}, operation can be executed at a high efficiency.

### BRIEF DESCRIPTION OF THE DRAWINGS

FIG. 1 is a schematic view showing an image read-out apparatus in accordance with a first embodiment of the present invention,

FIG. 2A is a view showing the relation between the amount of X-rays and the digital signal for each gain G,

FIG. 2B is a view showing the bit shift of the digital signal for each gain G,

FIG. 3 is a schematic view showing a current detecting means and an A/D conversion means of an image read-out apparatus in accordance with a second embodiment of the present invention,

FIG. 4 is a schematic view showing a current detecting means and an A/D conversion means of an image read-out apparatus in accordance with a third embodiment of the present invention, and

FIG. 5 is a schematic view showing a current detecting means and an A/D conversion means of an image read-out apparatus in accordance with a fourth embodiment of the present invention.

### DESCRIPTION OF THE PREFERRED EMBODIMENTS

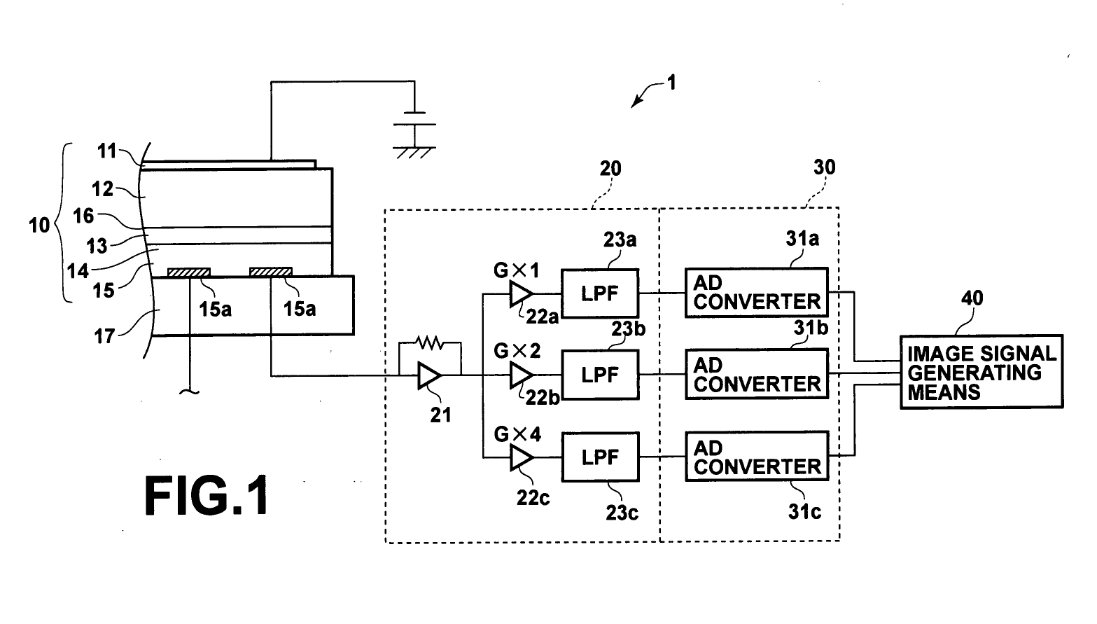

In FIG. 1, an image read-out apparatus 1 in accordance with a first embodiment of the present invention comprises a solid sensor 10 on which image information is recorded as an electrostatic latent image upon exposure to recording light bearing thereon the image information and which outputs an electric current according to the electrostatic latent image recorded thereon, a current detecting means 20 which is adapted to detect an electric current output from the solid sensor at a plurality of different gains G for each pixel, an A/D conversion means 30 which digitizes analog signals corresponding to the amounts of electric currents which are detected at a plurality of different gains G by the current detecting means 20, to digital signals, and an image signal generating means 40 which selects optimal one of the digital signals corresponding to the gains output from the A/D conversion means 30, and makes up an image signal on the basis of the selected digital signals.

The solid sensor 10 is an improved direct-conversion system solid sensor (a solid sensor which is both of the direct conversion system and the optical read-out system) disclosed in Japanese Unexamined Patent Publication No. 2000-105297 wherein when a first conductive layer 11 is exposed to X-rays (recording light) passing through an object, electric charges are generated in a recording photoconductive layer 12, the generated charges are stored in a charge accumulating portion 16, which is the interface between the recording photoconductive layer 12 and a charge transfer layer 13, as a latent image charge, electric charges are generated in a reading photoconductive layer 14 when a second conductive layer 15 is scanned by reading light, and an electric current is generated according to the amount of the latent image charge through recombination of the latent image charge and the electric charges generated in a reading photoconductive layer 14. The second conductive layer 15 which functions as the reading electrode comprises numbers of linear electrodes (hatched portions) arranged like stripes. The second conductive layer 15 will be sometimes referred to as “the stripe electrode 15” and each linear electrode will be sometimes referred to as “the element 15a”, hereinbelow. The solid sensor 10 is formed on a glass substrate 17.

The current detecting means 20 comprises an I-V conversion portion 21 connected to each element 15a, amplifiers 22a, 22b and 22c which detects at different gains a signal output from the I-V conversion portion 21, and low-pass filters (LPF) 23a, 23b and 23c which remove noise from the analog signals output from the amplifiers 22a, 22b and 22c.

In this embodiment, the gains G of the respective amplifiers 22a, 22b and 22c satisfy formula G=Gₘᵢₙ×2^{k},

wherein Gₘᵢₙ is the minimum gain, k is an integer not smaller than 0 and the gain is the minimum when k is 0. That is, the gain G of the amplifier 22a is 1 (k=0), the gain G of the amplifier 22b is 2 (k=1) and the gain G of the amplifier 22c is 4 (k=2). The gains G of the amplifiers may be of other combinations.

The A/D conversion means 30 comprises A/D converters 31a, 31b and 31c which digitize the analog signals output from the low-pass filters 23a, 23b and 23c.

The image signal generating means 40 selects a digital signal corresponding to a gain which is the largest in the gains of the A/D converters 31a, 31b and 31c when there is an unsaturated digital signal in the digital signals output from the A/D converters 31a, 31b and 31c having different gains G, while selects one of the digital signals output from the A/D converters 31a, 31b and 31c when there is no unsaturated digital signal in the digital signals output from the A/D converters 31a, 31b and 31c, and makes up an image signal on the basis of the selected digital signals.

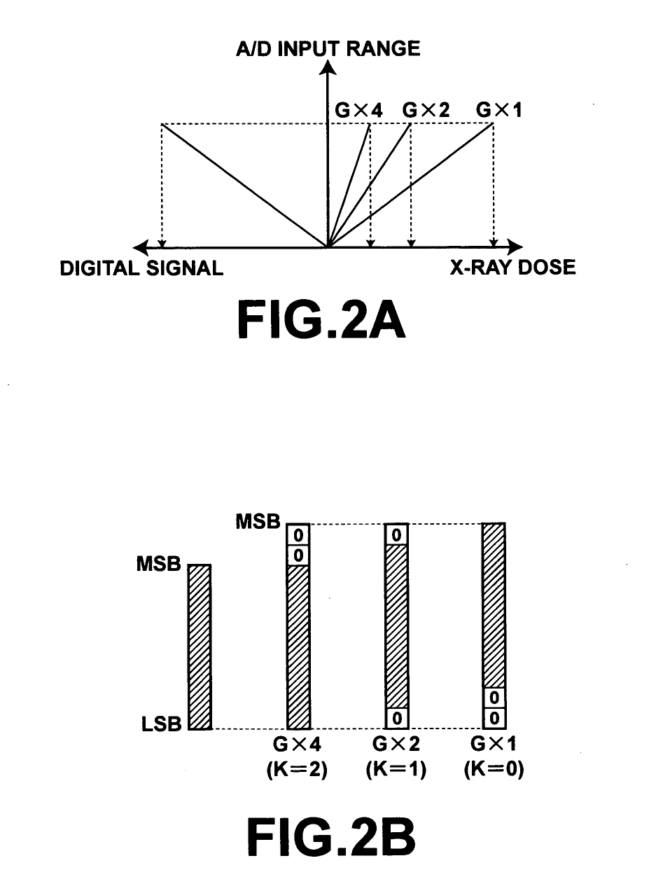

Processing of making up an image signal on the basis of the selected digital signals will be described in detail, hereinbelow. FIG. 2A is a view showing the relation between the amount of X-rays and the digital signal for each gain G, and FIG. 2B is a view showing the bit shift of the digital signal for each gain G.

Since the digital signals from the A/D conversion means 30 differ from each other depending on the gains G even if they are converted from the same analog signal as can be seen from FIG. 2A, it is necessary to match the digital signals with the analog signal. The digital signals can be readily caused to correspond to the analog signal corresponding to the X-ray dose by carrying out bit shift on the digital signal from LSB side so that the amount S of the bit shift satisfies formula S=S₀+kₘₐₓ−k. In FIG. 2B, S₀=0 and kₘₐₓ=2.

The image signal generating means 40 makes up an image signal on the basis of the digital signals after matching the digital signals with the analog signals.

Operation of the image read-out apparatus 1 with this arrangement will be described, hereinbelow.

When an electrostatic latent image is to be recorded by the solid sensor 10, a DC voltage is imparted between the first conductive layer 11 and each of the elements 15a by a high-voltage source (not shown) and the first conductive layer 11 and each of the elements 15a are charged, whereby a U-shaped electric field is established between the first conductive layer 11 and each of the elements 15a with the lowermost portion of the U positioned at each element 15a.

When an X-ray bearing thereon image information is externally projected onto the solid sensor 10, positive and negative charged pairs are generated in the recording photoconductive layer 12. The charges in the polarity of the latent image (the negative charge in this particular embodiment) of the charged pairs are concentrated to the elements 15a along the electric fields, and the negative charges are stored in the charge accumulating portion 16, which is the interface between the recording photoconductive layer 12 and a charge transfer layer 13. The amount of the stored negative charges (the latent image polarity charges) is substantially proportional to the amount of X-ray dose passing through the object. That is, the latent image polarity charges bear an electrostatic latent image. An electrostatic latent image is thus recorded on the solid sensor 10. The positive charges generated in the recording photoconductive layer 12 are attracted to the first conductive layer 11 and cancelled through recombination with the negative charges injected by the high-voltage source.

Operation of the image read-out apparatus 1 when an electrostatic latent image is to be read from the solid sensor 10 will be described, hereinbelow.

When an electrostatic latent image is to be read out from the solid sensor 10, the second conductive layer 15 is entirely scanned with a line light beam (not shown) in the sub-scanning direction (the longitudinal direction of the element 15a) . Upon exposure to the line light beam, positive and negative charged pairs are generated in the reading photoconductive layer 14 at the portion corresponding to the sub-scanning position. The positive charges of the charged pairs rapidly moves through the charge transfer layer 13 attracted by the negative charges (the latent image polarity charges) stored in the charge accumulating portion 16 and cancelled in the charge accumulating portion 16 through recombination with the latent image polarity charges. The negative charges generated in the reading photoconductive layer 14 are cancelled through recombination with the positive charges injected into the second conductive layer 15. The negative charges stored in the solid sensor 10 are cancelled through recombination and an electric current is generated in the solid sensor 10 by movement of the electric charges upon recombination.

The electric current thus generated converted to an electric voltage by the I-V conversion portion 21 connected to each element 15a and the signal output from the I-V conversion portion 21 is detected by the amplifiers 22a, 22b and 22c which are 1 (k=0), 2 (k=1) and 4 (k=2) in gain.

The A/D converters 31a, 31b and 31c digitizes the analog signals which are output from the amplifiers 22a, 22b and 22c and removed with noise by the low-pass filters 23a, 23b and 23c into digital signals.

The image signal generating means 40 selects a digital signal corresponding to a gain which is the largest in the gains of the A/D converters 31a, 31b and 31c when there is an unsaturated digital signal in the digital signals output from the A/D converters 31a, 31b and 31c having different gains G, while selects one of the digital signals output from the A/D converters 31a, 31b and 31c when there is no unsaturated digital signal in the digital signals output from the A/D converters 31a, 31b and 31c, and makes up an image signal on the basis of the selected digital signals after matching the selected digital signals with the analog signals. With the arrangement described above, the bit resolution in the low dose range can be kept high even if the A/D converter is set so that its full scale conforms to a maximum amount of the X-rays since the image signal is generated in the low dose range by digitizing an analog signal detected at a high gain.

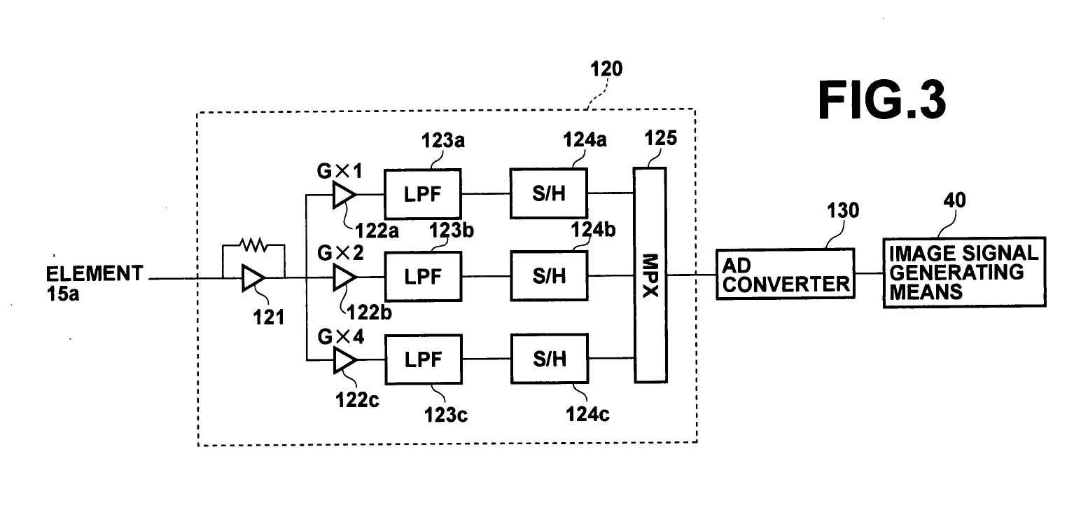

An image read-out apparatus in accordance with a second embodiment of the present invention will be described, hereinbelow. This embodiment differs from the first embodiment in the current detecting means and the A/D conversion means. FIG. 3 schematically shows the current detecting means and the A/D conversion means of the second embodiment. In FIG. 3, the elements analogous to those shown in FIG. 1 will be given the same reference numerals and will not be described unless otherwise required.

The current detecting means 120 comprises an I-V conversion portion 121 connected to each element 15a, amplifiers 122a, 122b and 122c which detects at different gains a signal output from the I-V conversion portion 121, and low-pass filters 123a, 123b and 123c which remove noise from the analog signals output from the amplifiers 122a, 122b and 122c, sample hold circuits 124a, 124b and 124c which store analog signals respectively output from the low-pass filters 123a, 123b and 123c, and a multiplexer 125 which multiplexes the analog signals respectively output from the sample hold circuits 124a, 124b and 124c.

In this embodiment, the gains G of the respective amplifiers 122a, 122b and 122c satisfy formula G=Gₘᵢₙ×2^{k},

wherein Gₘᵢₙ is the minimum gain, k is an integer not smaller than 0 and the gain is the minimum when k is 0. That is, the gain G of the amplifier 22a is 1 (k=0), the gain G of the amplifier 22b is 2 (k=1) and the gain G of the amplifier 22c is 4 (k=2). The gains G of the amplifiers may be of other combinations.

The A/D conversion means comprises an A/D converter 130 which digitizes the analog signal output from the multiplexer 125.

The image signal generating means 40 selects a digital signal corresponding to a gain which is the largest in the gains out of the digital signals output from the A/D converter 130 when there is an unsaturated digital signal therein, while selects one of the digital signals output from the A/D converter 130 when there is no unsaturated digital signal therein, and makes up an image signal on the basis of the selected digital signals.

The same result as the first embodiment can be obtained also with this arrangement.

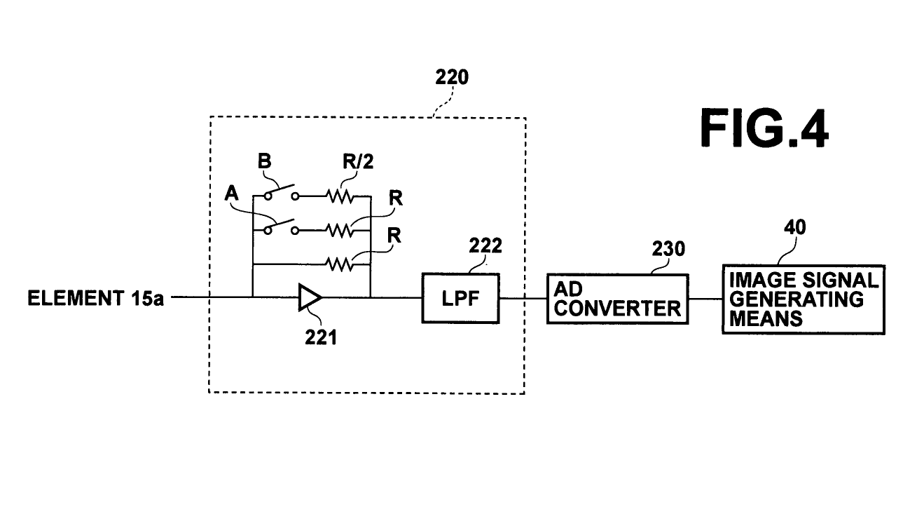

An image read-out apparatus in accordance with a third embodiment of the present invention will be described, hereinbelow. This embodiment differs from the first embodiment in the current detecting means and the A/D conversion means. FIG. 4 schematically shows the current detecting means and the A/D conversion means of the third embodiment. In FIG. 4, the elements analogous to those shown in FIG. 1 will be given the same reference numerals and will not be described unless otherwise required.

The current detecting means 220 comprises an I-V conversion portion 221 connected to each element 15a, and a low-pass filter 221 which removes noise from the analog signals output from the I-V conversion portion 221.

In this embodiment, two feedback resistances R and a feedback resistance R/2 are connected in the I-V conversion portion 221 in parallel to an operational amplifier. A switch A is connected in series to one of the feedback resistances R and a switch B is connected in series to the feedback resistance R/2.

When the switches A and B are both opened, an output based on the feedback resistance R is obtained. Assuming that the gain of the output at this time is 4, the gain of the output becomes a half of that obtained when the switches A and B are both opened (gain G=2), when the switch A is closed and the switch B is opened since the two feedback resistances R are connected in parallel to the operational amplifier and an output based on the feedback resistance R/2 is obtained at this time. The gain of the output becomes a quarter of that obtained when the switches A and B are both opened (gain G=1), when the switch A and the switch B are both closed since the two feedback resistances R and a feedback resistance R/2 are connected in parallel to the operational amplifier and an output based on the feedback resistance R/4 is obtained at this time.

That is, the current detecting means 220 can detect at different gains G, 1 (k=0), 2 (k=1) and 4 (k=2) the electric current output from the element 15a. The gains G may be of other combinations.

The A/D conversion means comprises an A/D converter 230 which digitizes the analog signal output from the low-pass filter 222.

The image signal generating means 40 selects a digital signal corresponding to a gain which is the largest in the gains out of the digital signals output from the A/D converter 230 when there is an unsaturated digital signal therein, while selects one of the digital signals output from the A/D converter 230 when there is no unsaturated digital signal therein, and makes up an image signal on the basis of the selected digital signals.

The same result as the first embodiment can be obtained also with this arrangement.

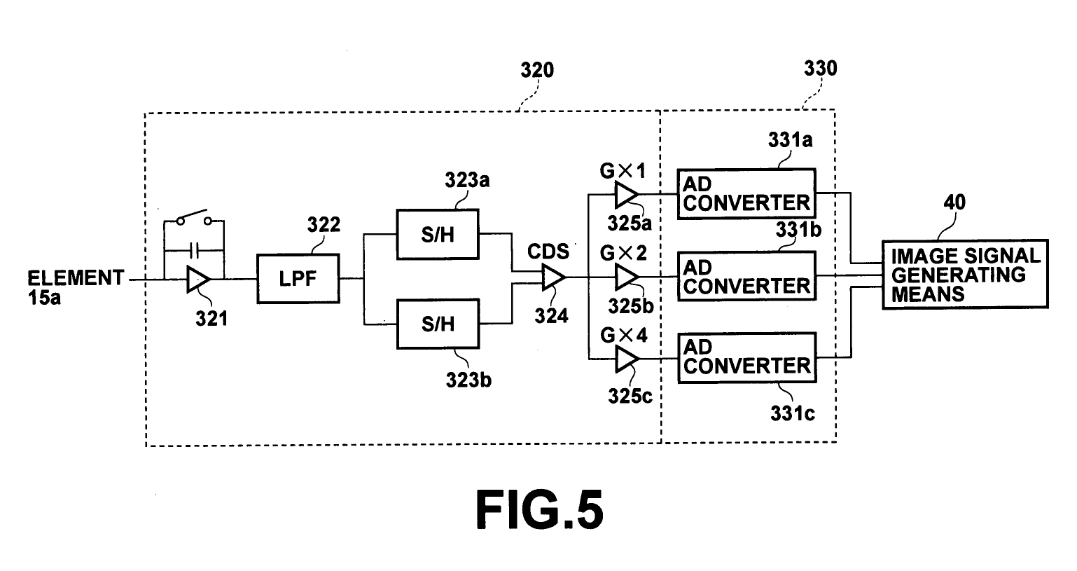

An image read-out apparatus in accordance with a fourth embodiment of the present invention will be described, hereinbelow. This embodiment differs from the first embodiment in the current detecting means and the A/D conversion means. FIG. 5 schematically shows the current detecting means and the A/D conversion means of the fourth embodiment. In FIG. 5, the elements analogous to those shown in FIG. 1 will be given the same reference numerals and will not be described unless otherwise required.

The current detecting means 320 comprises a charge amplifier 321 connected to each element 15a, a low-pass filter 322 which removes noise from the analog signal output from the charge amplifier 321, sample hold circuits 323a and 323b which correlation-double-sample the analog signal output from the low-pass filter 322, a differential amplifier 324 and amplifiers 325a, 325b and 325c which detects at different gains a signal output from the differential amplifier 324.

In this embodiment, the gains G of the respective amplifiers 325a, 325b and 325c satisfy formula G=Gₘᵢₙ×2^{k},

wherein Gₘᵢₙ is the minimum gain, k is an integer not smaller than 0 and the gain is the minimum when k is 0. That is, the gain G of the amplifier 325a is 1 (k=0), the gain G of the amplifier 325b is 2 (k=1) and the gain G of the amplifier 325c is 4 (k=2). The gains G of the amplifiers may be of other combinations.

The A/D conversion means comprises A/D converters 331a, 331b and 331c which digitize the analog signal output from the amplifiers 325a, 325b and 325c.

The image signal generating means 40 selects a digital signal corresponding to a gain which is the largest in the gains out of the digital signals output from the A/D converters 331a, 331b and 331c when there is an unsaturated digital signal therein, while selects one of the digital signals output from the A/D converters 331a, 331b and 331c when there is no unsaturated digital signal therein, and makes up an image signal on the basis of the selected digital signals.

The same result as the first embodiment can be obtained also with this arrangement.

Preferred embodiments of the present invention have been described above. However, the solid sensor employed in the present invention need not be limited to those described above in conjunction with the embodiments but may be any so long as it can store image information as an electrostatic latent image upon exposure to recording light bearing thereon image information on an object, and output an electric current (signal) according to the stored electrostatic latent image.

Further, the current detecting means and the A/D conversion means may be arranged in various ways other than those described above.

1. A method of reading an image comprising the steps of
detecting an electric current at a plurality of different gains G for each pixel from a solid sensor on which image information is recorded as an electrostatic latent image upon exposure to recording light bearing thereon the image information and which outputs an electric current according to the electrostatic latent image recorded thereon,
digitizing analog signals, corresponding to the amounts of electric currents which are detected at a plurality of different gains G, to digital signals,
selecting a digital signal corresponding to a gain which is the largest in the gains G at which the electric current is detected for each pixel when there is an unsaturated digital signal in the digital signals corresponding to the gains G for the pixel, while selecting one of the digital signals corresponding to the gains at which the electric current is detected for the pixel when there is no unsaturated digital signal in the digital signals corresponding to the gains G for the pixel, and
making up an image signal on the basis of the selected digital signals.

2. An apparatus for reading an image comprising
a solid sensor on which image information is recorded as an electrostatic latent image upon exposure to recording light bearing thereon the image information and which outputs an electric current according to the electrostatic latent image recorded thereon,
a current detecting means which is adapted to detect an electric current output from the solid sensor at a plurality of different gains G for each pixel,
an A/D conversion means which digitizes analog signals, corresponding to the amounts of electric currents which are detected at a plurality of different gains G, to digital signals, and
an image signal generating means which selects a digital signal corresponding to a gain which is the largest in the gains G at which the electric current is detected for each pixel when there is an unsaturated digital signal in the digital signals corresponding to the gains G for the pixel, while selects one of the digital signals corresponding to the gains at which the electric current is detected for the pixel when there is no unsaturated digital signal in the digital signals corresponding to the gains G for the pixel, and makes up an image signal on the basis of the selected digital signals.

3. An apparatus for reading an image as defined in claim 2 in which
the gain G satisfies formula G=Gₘᵢₙ×2^{k},
wherein Gₘᵢₙ is the minimum gain, k is an integer not smaller than 0 and the gain is the minimum when k is 0.

4. An apparatus for reading an image as defined in claim 2 in which the image signal generating means carries out bit shift of the digital signals.

5. An apparatus for reading an image as defined in claim 4 in which the amount S of the bit shift satisfies formula S=S₀+kₘₐₓ−k wherein S₀ represents a predetermined amount of the bit shift and kₘₐₓ represents the multiplier when the gain is the maximum.
